(19) United States
(12) Patent Application Publication
(10) Pub. No.: US 2017/0126970 A1
(43) Pub. Date: May 4, 2017

(54) Method for Controlling Depression Angles of Panoramic Cameras on Vehicle and Vehicle-Mounted Equipment

(71) Applicant: Leauto Intelligent Technology (BEIJING) Co. Ltd, Beijing (CN)

(72) Inventor: Chengjie Zang, Beijing (CN)

(73) Assignee: Leauto Intelligent Technology (BEIJING) Co. Ltd, Beijing (CN)

(21) Appl. No.: 14/965,843

(22) Filed: Dec. 10, 2015

(30) Foreign Application Priority Data
Nov. 2, 2015 (CN) 201510732531.4

(51) Int. Cl. H04N 5/232; G06T 7/20; B60R 11/04; G06T 7/60

(52) U.S. Cl. CPC H04N 5/23238; G06T 7/60; G06T 7/20; B60R 11/04; B60R 2011/004

(57) ABSTRACT

The present disclosure provides a method for controlling the depression angles of panoramic cameras on a vehicle and vehicle-mounted equipment. The method comprises the following steps: acquiring operating parameter information of the vehicle; determining whether the current vehicle is in a running or a parking state according to the operating parameter information; if the current vehicle is determined to be in the running state, adjusting the depression angles of the panoramic cameras to be 0°; or if the current vehicle is determined to be in the parking state, adjusting the depression angles of the panoramic cameras to be more than 0° and less than 90°. By adopting the method, the angles of the panoramic cameras on the vehicle can be controlled, so that reasonable switching is realized between narrowing the blind areas around the vehicle body and narrowing the horizontal field of view.

### FIELD OF TECHNOLOGY

The present disclosure relates to a vehicle-mounted control technology, and particularly relates to a method for controlling the depression angles of panoramic cameras on a vehicle and vehicle-mounted equipment.

### BACKGROUND

In the prior art, a panoramic auxiliary parking system used in a vehicle can acquire images around the vehicle in real time, and a panoramic image formed after the images are spliced is displayed on a vehicle-mounted display screen, so that the driver can conveniently view the images around the vehicle, the blind areas around the vehicle body are eliminated, and the parking safety is improved. The panoramic auxiliary parking system generally includes four cameras, which are respectively installed at the front and back license plates and the left and right rearview mirrors of the vehicle body. FIG. 1 shows the installation positions of the front and left cameras P of the vehicle. In order to narrow the blind areas nearby the vehicle body, the installation depression angles theta of the four cameras are about 30° (as shown in FIG. 2).

On the basis of the setting manner that the panoramic cameras are installed on the circumference of the vehicle body by certain depression angles, the images around the vehicle body can be acquired in real time, the blind areas can be eliminated, and the driver can be assisted in improving the parking safety, but in the presence of the installation depression angles theta, the horizontal field of view is narrowed while the blind areas around the vehicle body are narrowed.

### SUMMARY

The present disclosure provides a method for controlling the depression angles of panoramic cameras on a vehicle and vehicle-mounted equipment, and thus controlling the angles of the panoramic cameras on the vehicle and realizing reasonable switching between narrowing the blind areas around the vehicle body and narrowing the horizontal field of view.

In order to fulfill the above purposes, the embodiments of the present disclosure provide a method for controlling the depression angles of panoramic cameras on a vehicle, including: acquiring operating parameter information of the vehicle; determining whether the current vehicle is in a running or a parking state according to the operating parameter information; if the current vehicle is determined to be in the running state, adjusting the depression angles of the panoramic cameras to be 0°; and if the current vehicle is determined to be in the parking state, adjusting the depression angles of the panoramic cameras to be more than 0° and less than 90°.

The present disclosure further provides vehicle-mounted equipment, including an information acquisition device, a processor and step motors connected in sequence, wherein the step motors are fixedly connected with panoramic cameras. The information acquisition device is used for acquiring operating parameter information of the vehicle. The processor is used for determining whether the current vehicle is in a running or a parking state according to the operating parameter information; if the current vehicle is determined to be in the running state, controlling the rotation of the step motors to adjust the depression angles of the panoramic cameras to be 0°; and if the current vehicle is determined to be in the parking state, controlling the rotation of the step motors to adjust the depression angles of the panoramic cameras to be more than 0° and less than 90°.

According to the method for controlling the depression angles of the panoramic cameras on the vehicle and the vehicle-mounted equipment provided by the present disclosure, the current vehicle being in the running or parking state is judged by acquiring the operating parameter information of the vehicle in real time, and then the depression angles of the panoramic cameras are adjusted according to the obtained running or parking state result to meet the driving service requirement of the current driver for narrowing the blind areas around the vehicle body or narrowing the horizontal field of view.

### BRIEF DESCRIPTION OF THE DRAWINGS

FIG. 1 is a schematic diagram of installation positions and acquisition influencing areas of panoramic cameras on a vehicle in the prior art;

FIG. 2 is a schematic diagram when the installation depression angles of the panoramic cameras on the vehicle are not 0°;

FIG. 3 is a schematic diagram when the installation depression angles of the panoramic cameras on the vehicle are 0°;

FIG. 4 is a method flow diagram of an embodiment of a method for controlling the depression angles of panoramic cameras on a vehicle in the present disclosure;

FIG. 5 is a structural schematic diagram of an embodiment of vehicle-mounted equipment provided by the present disclosure.

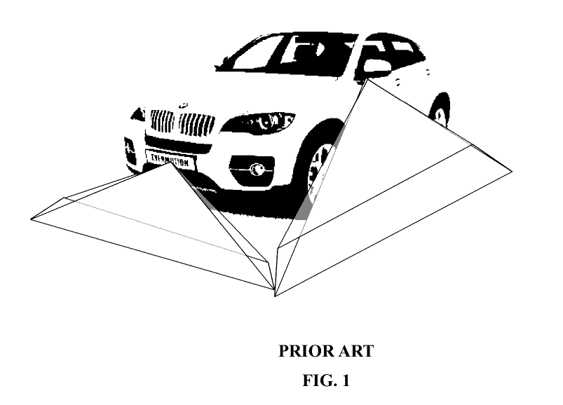

In which:

P-panoramic camera, 510-information acquisition device, 520-processor, 530-step motor

### DESCRIPTION OF THE EMBODIMENTS

The inventive concept of this solution lies in that, in view of the observation requirement of a driver for the surrounding of the vehicle body and the horizontal field of view under different operating states of a vehicle, particularly the observation requirement when the vehicle is in a running state and a parking state, the depression angles of panoramic cameras are adaptively adjusted by identifying the current operating state of the vehicle, to meet the view field requirement of the driver.

### Embodiment 1

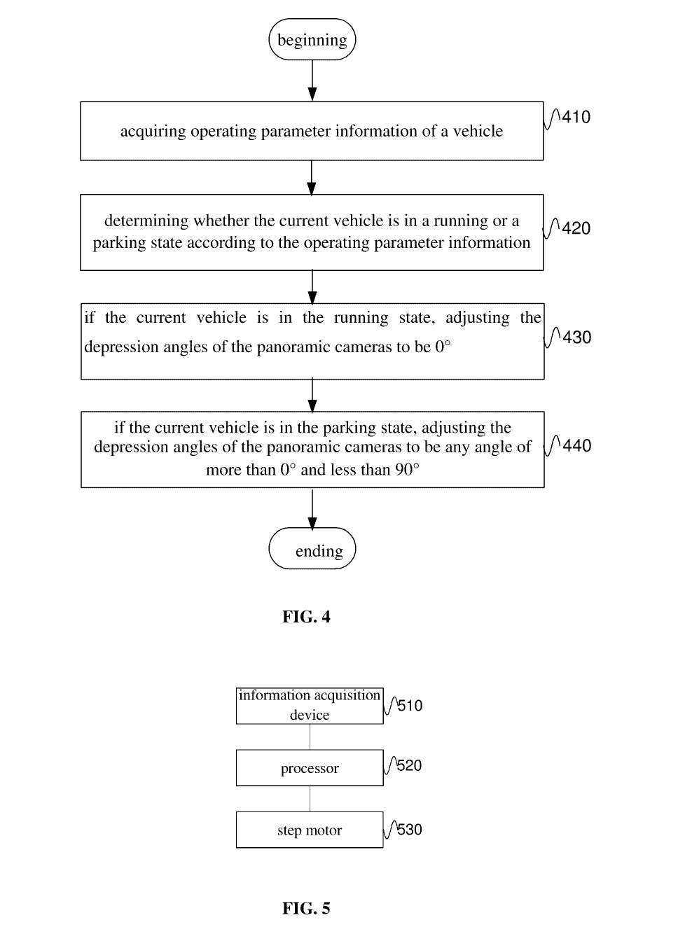

FIG. 4 is a method flow diagram of an embodiment of a method for controlling the depression angles of panoramic cameras on a vehicle in the present disclosure, wherein the execution main body of the method may be vehicle-mounted equipment. As shown in FIG. 4, the method includes the following steps.

S410, operating parameter information of the vehicle is acquired.

The operating parameter information of the vehicle is information of state parameters of the vehicle, which is acquired by such a device as the vehicle-mounted equipment or a sensor, e.g., operating gear information, speed information, running direction information, state information of various indicating lamps and the like of the vehicle.

S420, the current vehicle being in a running or a parking state is determined according to the operating parameter information.

The operating state of the current vehicle may be analyzed through the acquired operating parameter information of the vehicle. For example, under one or more conditions that the acquired gear information of the vehicle is a positive gear and is higher than a preset number gear (e.g., second gear or first gear) and/or the speed information is higher than a preset speed (e.g., 20 km/s), the current vehicle is determined to be in the running state; and under at least one of the conditions that the acquired gear information of the vehicle is a reverse gear or a positive gear and is not higher than the preset number gear (e.g., second gear or first gear) and the speed information is not higher than the preset speed (e.g., 20 km/s), the current vehicle is determined to be in the parking state.

It should be noted herein that, when the vehicle is ready for parking, the vehicle still runs at a certain speed, so the parking state in this solution also includes the low-speed running state of the vehicle, e.g., running at the speed not higher than the aforementioned preset speed is defined as the parking state.

It could be understood that, those skilled in the art could also set multiple corresponding rules for judging whether the current vehicle is in the running or a parking state according to the actually acquired operating parameter information of the vehicle, and this solution is not limited thereto.

Later, S430 is executed, if the current vehicle is determined to be in the running state, the depression angles of the panoramic cameras are adjusted to be 0° (as the state shown in FIG. 3);

meanwhile, S440 is executed, if the current vehicle is determined to be in the parking state, the depression angles of the panoramic cameras are adjusted to be more than 0° and less than 90°.

When the vehicle runs, the driver mainly concerns the vehicle conditions on the road in a relatively long distance of the horizontal view field of the vehicle. When the vehicle is in the parking state, the driver mainly concerns whether obstacles exist in a relatively short distance around the vehicle body. Therefore, when the vehicle is in the running or parking state, the depression angles of the panoramic cameras can be adjusted in real time, to meet the observation requirement of the driver for the environment.

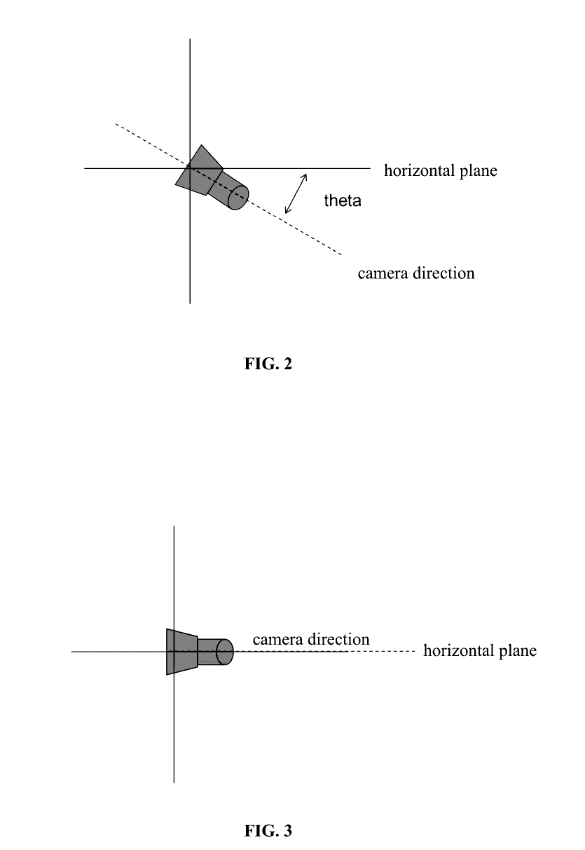

In a specific application scenario, the panoramic cameras may be fixed on step motors, the rotation of the step motors is controlled by an external vehicle state signal, and then the depression angles of the panoramic cameras are changed. The external vehicle state signal may be provided by a processor on the vehicle body, and includes two states: 0 and 1. Wherein, state 0 represents the parking state, and state 1 represents the running state. In the parking state, the processor sends the state signal 0 to the step motors, and the step motors drive the panoramic cameras to rotate after receiving the signal, so that the depression angles theta of the panoramic cameras can be any angle of more than 0° and less than 90°, preferably less than 30° (as the state shown in FIG. 2). In the running state, the processor sends the state signal 1 to the step motors, and the step motors drive the panoramic cameras to rotate after receiving the signal, so that the depression angles theta of the panoramic cameras are 0°.

When the step motors rotate to the specified theta angles every time, the step motors send feedback signals to the processor, to inform the processor of completing rotation. After the processor receives the rotation complete signals of the step motors, single information transmission is completed.

Alternatively, when the current vehicle is determined to be in the parking state, the depression angles of the panoramic cameras can be dynamically adjusted within a range of 0-90° according to the running speed of the current vehicle, and the depression angles of the panoramic cameras are inversely proportional to the running speed. In the practical scenario, namely, when the current vehicle is determined to be in the parking state, the depression angles of the panoramic cameras continuously rotate along with the change of the vehicle speed, the higher the vehicle speed is, the smaller the depression angles are, and conversely, the larger the depression angles are.

According to the method for controlling the depression angles of the panoramic cameras on the vehicle in the present embodiment, the panoramic cameras are adjusted to be 0° when the vehicle is in the running state, and are adjusted to be in the range of 0°-90° when the vehicle is in the parking state, so that different observation requirements of a driver are met.

### Embodiment 2

FIG. 5 is a structural schematic diagram of an embodiment of vehicle-mounted equipment provided by the present disclosure, wherein the vehicle-mounted equipment can be used for executing the method steps of the embodiment shown in FIG. 4. As shown in FIG. 5, the vehicle-mounted equipment includes an information acquisition device 510, a processor 520 and step motors 530 which are connected in sequence, wherein the step motors 530 are fixedly connected with panoramic cameras P; wherein

the information acquisition device 510 is used for acquiring operating parameter information of a vehicle; the processor 520 is used for determining whether the current vehicle is in a running or a parking state according to the operating parameter information; if the current vehicle is determined to be in the running state, controlling the rotation of the step motors 530 to adjust the depression angles of the panoramic cameras to be 0° (as the state shown in FIG. 3); and if the current vehicle is determined to be in the parking state, controlling the rotation of the step motors 530 to adjust the depression angles of the panoramic cameras to be more than 0° and less than 90°, preferably 30° (as the state shown in FIG. 2).

Further, the operating parameter information of the vehicle may include at least one of operating gear information, speed information and running direction information of the vehicle.

Further, the processor 520 may be specifically used for determining that the current vehicle is in the running state if the operating parameter information of the vehicle satisfies the condition that the gear information is a positive gear and is higher than a preset number gear and/or the speed information is higher than a preset speed. Or,

further, the processor 520 may be specifically used for determining that the current vehicle is in the parking state if the operating parameter information of the vehicle satisfies at least one of the conditions that the gear information is a reverse gear or a positive gear and is not higher than the preset number gear and the speed information is not higher than the preset speed.

Alternatively, when the current vehicle is determined to be in the parking state, the depression angles of the panoramic cameras can be dynamically adjusted within a range of 0-90° according to the running speed of the current vehicle, and the depression angles of the panoramic cameras are inversely proportional to the running speed.

According to the vehicle-mounted equipment of the embodiment of the present disclosure, the panoramic cameras are adjusted to be 0° when the vehicle is in the running state, and are adjusted to be any angle in the range of 0°-90° when the vehicle is in the parking state, so that different observation requirements of a driver are met.

The foregoing descriptions are merely specific embodiments of the present disclosure, rather than limiting the protection scope of the present disclosure. Any skilled one who is familiar with this art could readily think of variations or substitutions within the disclosed technical scope of the present disclosure, and these variations or substitutions shall fall within the protection scope of the present disclosure. Accordingly, the protection scope of the claims should prevail over the protection scope of the present disclosure.

What is claimed is:

1. A method for controlling the depression angles of panoramic cameras on a vehicle, comprising the following steps:
acquiring operating parameter information of the vehicle;
determining whether the current vehicle is in a running or a parking state according to the operating parameter information;
if the current vehicle is determined to be in the running state, adjusting the depression angles of the panoramic cameras to be 0°; and
if the current vehicle is determined to be in the parking state, adjusting the depression angles of the panoramic cameras to be more than 0° and less than 90°.

2. The method of claim 1, wherein the operating parameter information of the vehicle comprises at least one of operating gear information, speed information and running direction information of the vehicle.

3. The method of claim 2, wherein the determining whether the current vehicle is in a running or parking state according to the operating parameter information comprises:
if the operating parameter information of the vehicle meets the condition that the gear information is a positive gear and is higher than a preset number gear and/or the speed information is higher than a preset speed, determining that the current vehicle is in the running state.

4. The method of claim 2, wherein the determining whether the current vehicle is in a running or parking state according to the operating parameter information comprises:
if the operating parameter information of the vehicle meets at least one of the conditions that the gear information is a reverse gear or a positive gear and is not higher than the preset number gear and the speed information is not higher than the preset speed, determining that the current vehicle is in the parking state.

5. The method of claim 1, wherein when the current vehicle is determined to be in the parking state, the depression angles of the panoramic cameras are adjusted to 30°.

6. The method of claim 1, wherein if the current vehicle is determined to be in the parking state, the depression angles of the panoramic cameras are dynamically adjusted within a range of 0-90° according to the running speed of the current vehicle, and the depression angles of the panoramic cameras are inversely proportional to the running speed.

7. Vehicle-mounted equipment, comprising an information acquisition device, a processor and step motors which are connected in sequence, wherein the step motors are fixedly connected with panoramic cameras;
the information acquisition device is used for acquiring operating parameter information of the vehicle;
the processor is used for determining whether the current vehicle is in a running or a parking state according to the operating parameter information; if the current vehicle is determined to be in the running state, controlling the rotation of the step motors to adjust the depression angles of the panoramic cameras to be 0°; and if the current vehicle is determined to be in the parking state, controlling the rotation of the step motors to adjust the depression angles of the panoramic cameras to be more than 0° and less than 90°, preferably 30°.

8. The vehicle-mounted equipment of claim 7, wherein the operating parameter information of the vehicle comprises at least one of operating gear information, speed information and running direction information of the vehicle.

9. The vehicle-mounted equipment of claim 8, wherein the processor is specifically further used for, if the operating parameter information of the vehicle meets the condition that the gear information is a positive gear and is higher than a preset number gear and/or the speed information is higher than a preset speed, determining that the current vehicle is in the running state; or, the processor is specifically further used for, if the operating parameter information of the vehicle meets at least one of the conditions that the gear information is a reverse gear or a positive gear and is not higher than the preset number gear and the speed information is not higher than the preset speed, determining that the current vehicle is in the parking state.

10. The vehicle-mounted equipment of claim 7, wherein the processor is used for dynamically adjusting the depression angles of the panoramic cameras within a range of 0-90° according to the running speed of the current vehicle if the current vehicle is determined to be in the parking state, and the depression angles of the panoramic cameras are inversely proportional to the running speed.
